(19) United States
(12) Patent Application Publication
(10) Pub. No.: US 2011/0013355 A1
(43) Pub. Date: Jan. 20, 2011

(54) Hard Disk Fixing Seat

(76) Inventor: Deng-Hsi Chen, Liu-Tu Industrial Park (TW)

Correspondence Address: Muncy, Geissler, Olds & Lowe, PLLC, 4000 Legato Road, Suite 310, FAIRFAX, VA, 22033, US

(21) Appl. No.: 12/505,043

(22) Filed: Jul. 17, 2009

(51) Int. Cl. G06F 1/16

(52) U.S. Cl. 361/679.33

(57) ABSTRACT

A hard disk fixing seat holds a hard disk and is then assembled into a corresponding insertion slot in a computer case. Two sides of a loading seat are locked respectively with a positioning element, such that the hard disk which is put in the loading seat can be fixed effectively. Moreover, after fixing the hard disk, the loading seat can be plugged into or pulled out of the insertion slot in the computer case, so as to quickly fix or dismount the hard disk without assistance of a hand tool.

### BACKGROUND OF THE INVENTION

a) Field of the Invention

The present invention relates to a hard disk fixing seat which is used to hold a hard disk and can be plugged into or pulled out of a computer case quickly, and more particularly to a hard disk fixing seat which can quickly dismount, mount and position the hard disk without using a hand tool for assistance.

b) Description of the Prior Art

An interior of a conventional computer case is provided with an assembly slot to assemble a hard disk; whereas, when assembling the hard disk, a hand tool is used, in association with plural screws, to lock the hard disk in the assembly slot, thereby achieving a fixing effect. On the contrary, when the hard disk is to be dismounted, the hand tool needs to be used again to remove the screws that the hard disk can be dismounted. Therefore, the dismounting process is tedious and inconvenient. In addition, to solve the aforementioned issue, a portable hard disk box has shown up on a market, wherein the hard disk is first assembled in the hard disk box using the hand tool and plural screws, and then, the hard disk box is quickly plugged into or pulled out of the assembly slot in the computer case, thereby achieving an effect that the hard disk can be quickly replaced and plugged in. However, as the hard disk is normally fixed in the hard disk box, when a user is to replace the hard disk in the hard disk box, he or she still needs to use the hand tool to remove the screws which fix the hard disk and then open the hard disk box to take out the hard disk. After that, the hard disk which is to be installed is put into the hard disk box and then the hand tool is used again to lock the hard disk through the screws. Although the hard disk can be quickly plugged into or pulled out of the computer case by this replacement method, the hand tool is still needed to replace the hard disk.

### SUMMARY OF THE INVENTION

Accordingly, the primary object of the present invention is to provide a hard disk fixing seat which can accomplish fixing and dismounting a hard disk without assistance of a hand tool and can be quickly plugged into or pulled out of a computer case.

To achieve the aforementioned object, the hard disk fixing seat of the present invention includes primarily a loading seat, two sides of which are locked respectively with a positioning element, such that after a hard disk has been put on the loading seat, the hard disk can be fixed effectively by the positioning elements. In addition, the loading seat can be quickly plugged into or pulled out of a corresponding insertion slot in the computer case. Accordingly, the present invention achieves an object of providing a hard disk fixing seat which can accomplish fixing and dismounting a hard disk without using a hand tool and can be quickly and conveniently assembled in a computer case.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional perspective view of the present invention.

FIG. 2 shows an exploded view of elements of the present invention.

FIG. 3 shows a first schematic view of an implementation of the present invention.

FIG. 4 shows a second schematic view of an implementation of the present invention.

FIG. 5 shows a schematic view of a preferred embodiment of the present invention.

FIG. 6 shows a schematic view of a preferred embodiment of the present invention, after assembling.

FIG. 7 shows a third schematic view of an implementation of the present invention.

FIG. 8 shows a fourth schematic view of an implementation of the present invention.

FIG. 9 shows a fifth schematic view of an implementation of the present invention.

FIG. 10 shows a sixth schematic view of an implementation of the present invention.

### DETAILED DESCRIPTION OF THE PREFERRED EMBODIMENTS

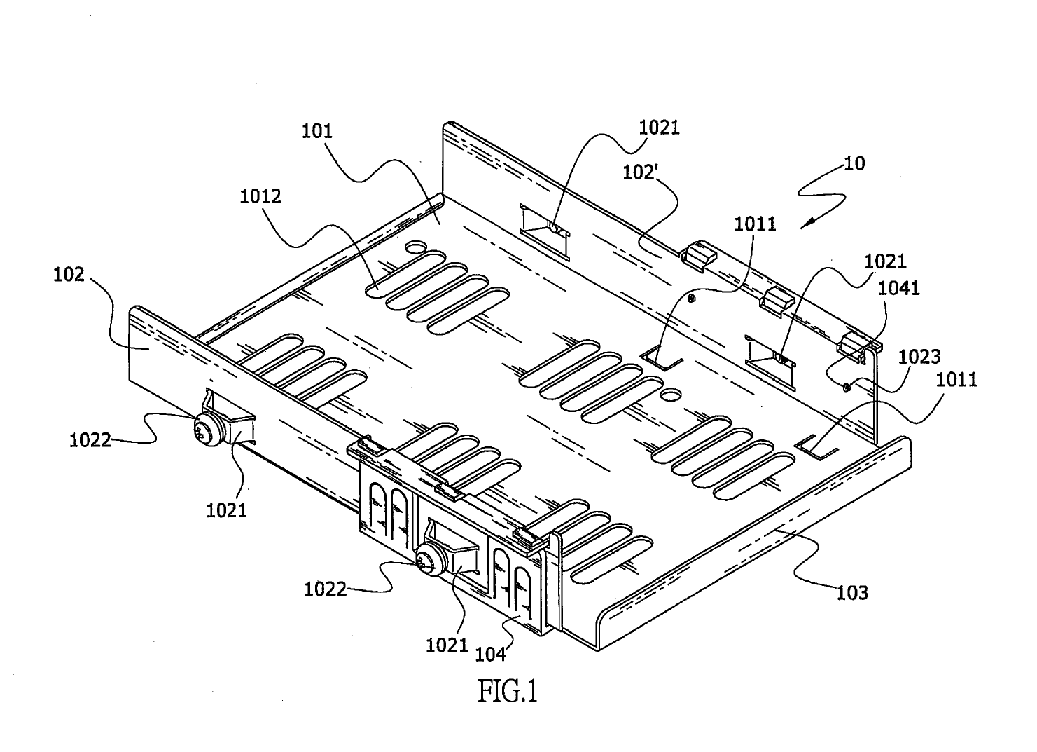

Referring to FIG. 1, it shows a three-dimensional perspective view of the present invention. As shown in the drawing, a hard disk fixing seat 10 comprises primarily a loading seat 101, wherein a plane of the loading seat 101 is formed with plural through-holes 1012 to increase a heat dissipation effect, two sides of the loading seat 101 are bended inward respectively to form a baffle wall 102, 102′, and planes of the two baffle walls 102, 102′ are protruded to form plural assembly portions 1021 on which a locking element 1022 is assembled respectively. In addition, an end of the loading seat 101 (the end between the two baffle walls 102, 102′) is bended to form a stop portion 103 which prevents a hard disk from dropping out of the plane of the loading seat 101 when a user is putting the hard disk (not shown in the drawing), and a bottom plane of the loading seat 101 is formed with plural snaps 1011. Furthermore, the two baffle walls 102, 102′ are assembled respectively with an L-shape positioning element 104. After assembling, plural positioning pillars 1041 which are formed on the positioning elements 104 can be transfixed respectively into plural fixing holes 1023 which are formed on the planes of the two baffle walls 102, 102′.

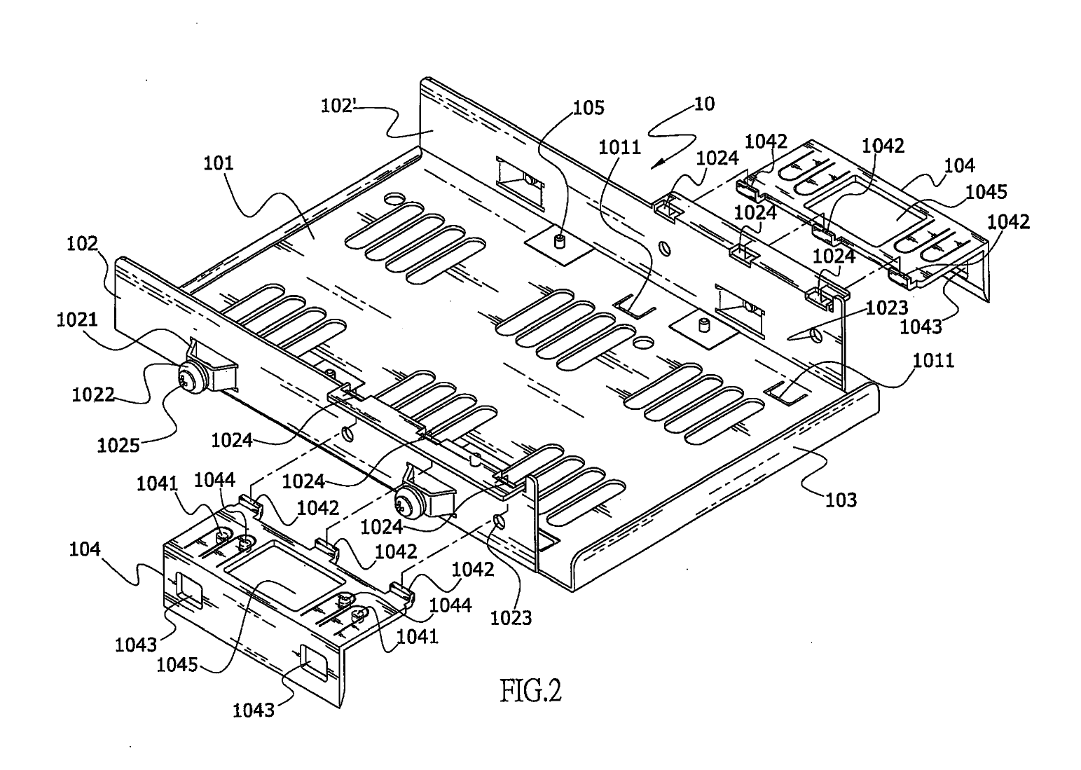

Referring to FIG. 2, it shows an exploded view of elements of the present invention. As shown in the drawing, upper ends of the two baffle walls 102, 102′ of the loading seat 101 are formed respectively with plural opposite locking portions 1024 to be locked with plural locking portions 1042 formed on the positioning elements 104; whereas, the plural snaps 1011 formed on the plane of the loading seat 101 can be locked with plural opposite snaps 1043 formed on the positioning elements 104 after the plural locking portions 1042 of the positioning elements 104 have been locked with the corresponding locking portions 1024. On the other hand, planes of the positioning elements 104 opposite to the two baffle walls 102, 102′ are formed with plural positioning pillars 1041 and protruded pillars 1044, wherein these positioning pillars 1041 can be transfixed respectively into plural fixing holes 1023 formed on the planes of the two baffle walls 102, 102′, after assembling the positioning elements 104 with the loading seat 101; whereas, the plural protruded pillars 1044 can be abutted on exterior planes of the two baffle walls 102, 102′. As shown in the drawing again, the locking elements 1022 are made by a roughly elastic material and can be fixed on the assembly portions 1021 formed on the two baffle walls 102, 102′ by using fixing elements 1025, such as screws. After the hard disk fixing seat 10 has been put into an insertion slot (not shown in the drawing) of a computer case, these locking elements 1022 can be locked respectively with locking portions (not shown in the drawing) formed in the insertion slot. Additionally, in the present invention, the planes of the positioning elements 104 opposite to the two baffle walls 102, 102′ are formed with through-holes 1045 into which the locking elements 1022 can be transfixed, when the positioning elements 104 are assembled with the loading seat 101. Thereby, a condition that the positioning elements 104 cannot be assembled with the loading seat 101 by interference of the locking elements 1022, when the positioning elements 104 are assembled with the loading seat 101, can be avoided. As shown in the drawing again, the plane of the loading seat 101 can be further formed or assembled with plural vertical positioning pillars 105 that a hard disk drive can be quickly positioned, after pores (not shown in the drawing) at a bottom of the hard disk drive have been locked.

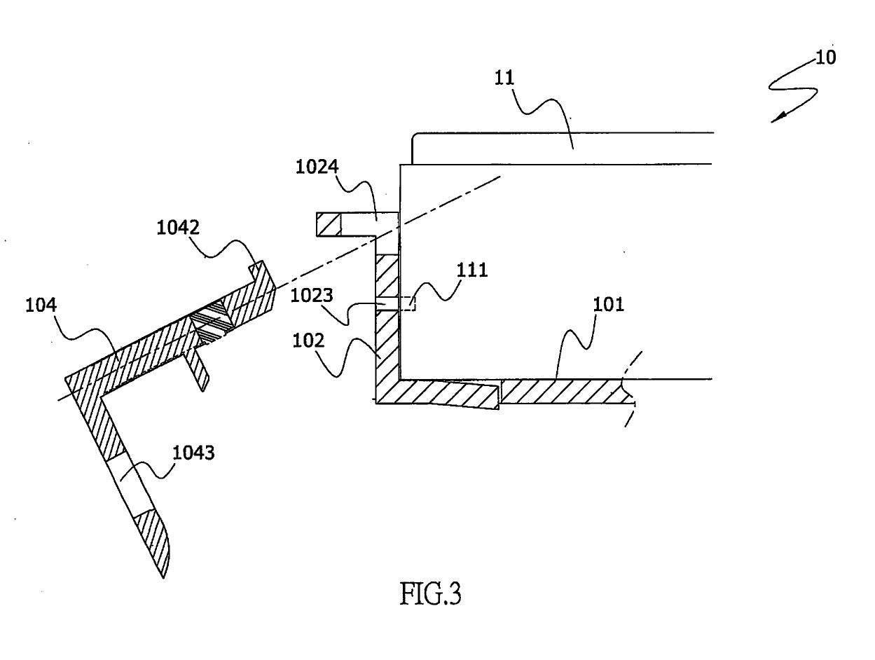

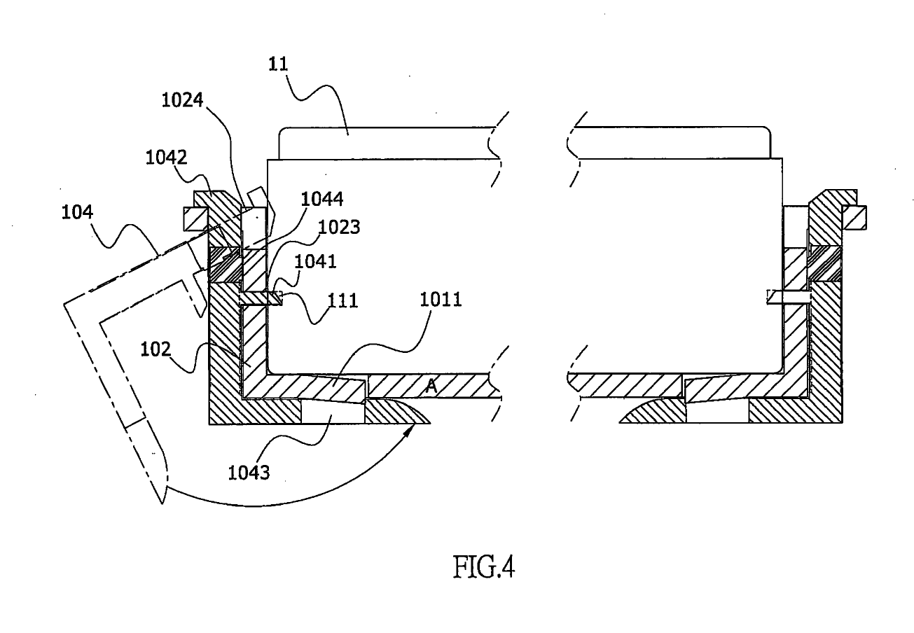

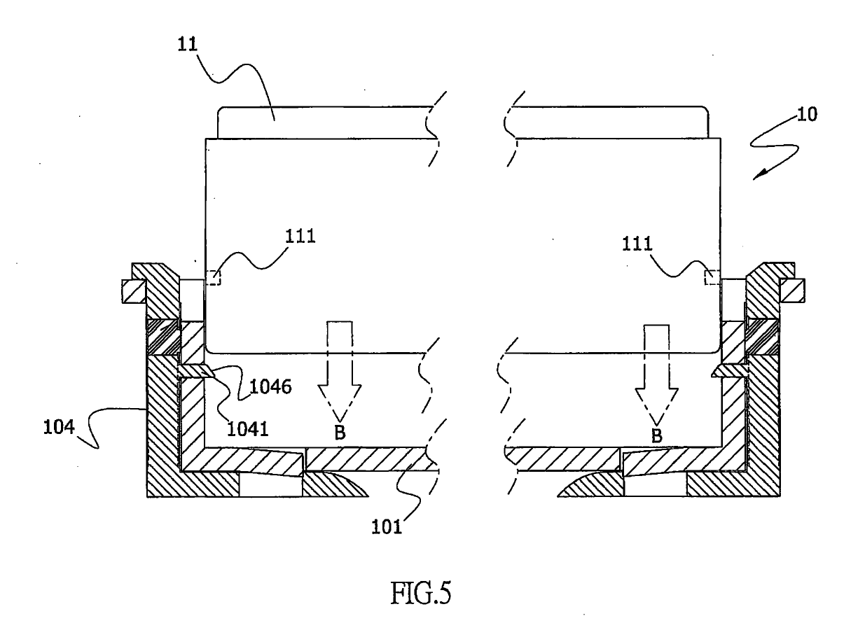

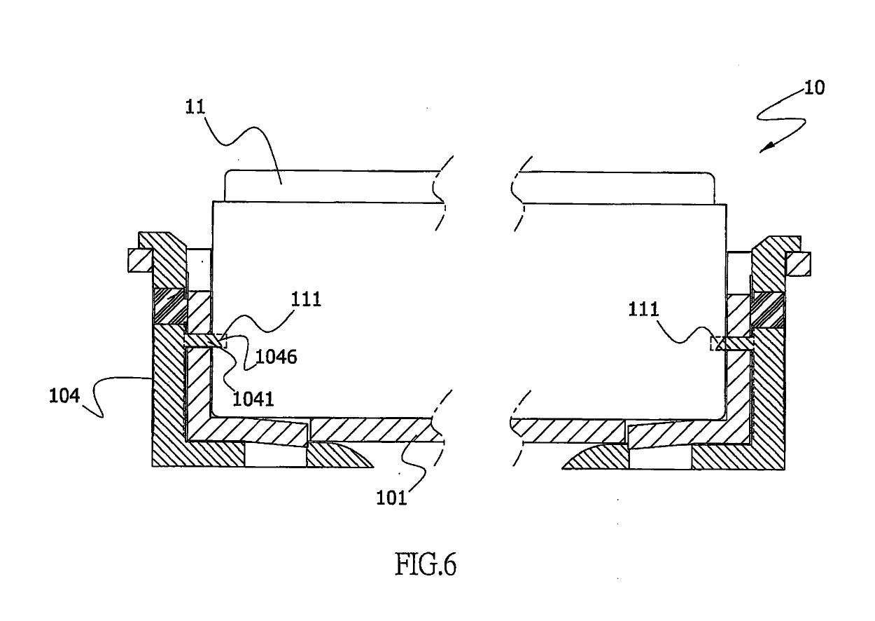

Referring to FIG. 3, it shows a first schematic view of an implementation of the present invention. As shown in the drawing, when implementing the hard disk fixing seat 10, a hard disk 11 is put on the plane of the loading seat 101 in advance. At this time, plural fixing screw-holes 111 formed on two sides of the hard disk 11 can correspond respectively to plural fixing holes 1023 on the baffle wall 102. As show in the drawing again, after emplacing the hard disk 11, the positioning element 104 is tilted by a proper angle with respect to the loading seat 101, allowing the locking portion 1042 to be transfixed into the corresponding locking portion 1024 on the baffle wall 102. Referring to FIG. 4, it shows a second schematic view of an implementation of the present invention. According to FIG. 3, after the locking portion 1042 has been transfixed into the corresponding locking portion 1024, the positioning element 104 is acted upon by a proper downward force (such as along a direction A), enabling the corresponding snaps 1043 to be locked with the snaps 1011 at the lower end of the loading seat 101. Furthermore, after assembling the positioning element 104 with the loading seat 101, the plural positioning pillars 1041 of the positioning element 104 will be transfixed respectively into the fixing holes 1023 of the baffle wall 102 and will be inserted into the plural fixing screw-holes 111 at the side of the hard disk 11, allowing the hard disk 11 to be effectively fixed by the positioning pillar 1041. Moreover, after assembling the positioning element 104 with the loading seat 101, the plural protruded pillars 1044 on the positioning element 104 will be abutted respectively on the exterior plane of the baffle wall 102. Thereby, when the hard disk 11 is operating, abutting of the plural protruded pillars 1044 can prevent the positioning element 104 from getting loose due to sloshing resulted from vibration of the hard disk 11. Referring to FIG. 5, it shows a schematic view of a preferred embodiment of the present invention. As shown in the drawing, before putting the hard disk 11 on the plane of the loading seat 101, the positioning element 104 of the hard disk fixing seat 10 is assembled with the loading seat 101 in advance; whereas, a top end of the positioning pillar 1041 on the positioning element 104 is formed with an oblique surface 1046, such that after the positioning element 104 has been assembled with the loading seat 101, the hard disk 11 can be directly put on the plane of the loading seat 101 from a direction B. On the other hand, when two sides of the hard disk 11 are in contact with the positioning pillars 1041, by the oblique surfaces 1046 at the top ends of the positioning pillars 1041, two sides of the hard disk 11 can slide downward along the oblique surfaces 1046 and be put on the bottom plane of the loading seat 101 accordingly. In addition, the fixing screw-holes 111 at two sides of the hard disk 11 can be fixed by being inserted with the positioning pillars 1041 after the hard disk 11 has been put on the bottom plane of the loading seat 101, and a configuration after assembling is as shown in FIG. 6, which is a schematic view of a preferred embodiment of the present invention, after assembling.

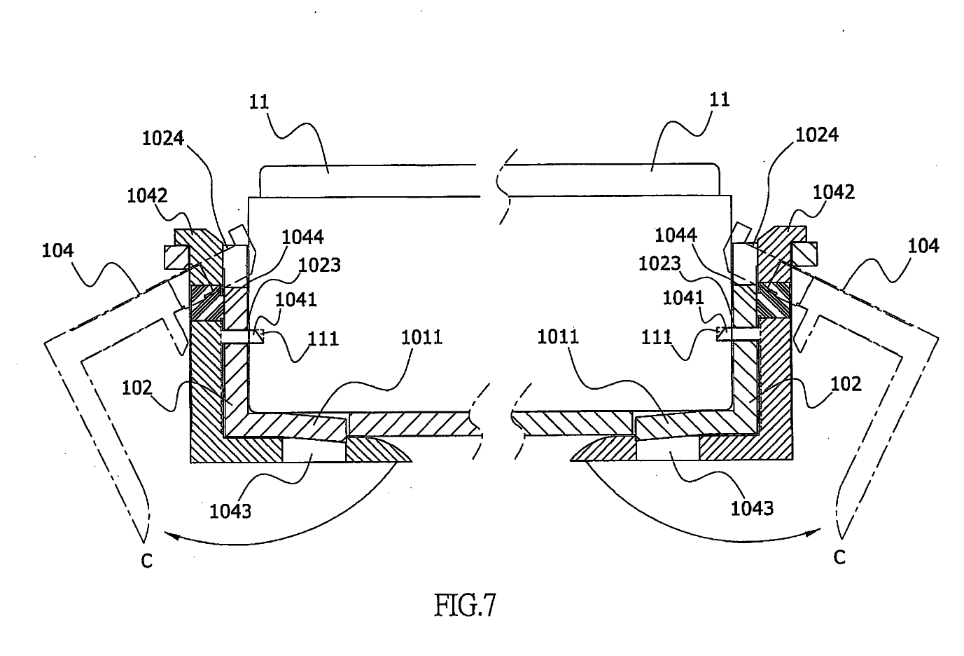

Referring to FIG. 7, it shows a third schematic view of an implementation of the present invention. When the hard disk 11 is to be dismounted, the corresponding snap 1043 of the positioning element 104 is first toggled by a finer toward a direction C, allowing the corresponding snap 1043 to be escaped from locking of the snap 1011, thereby putting the positioning element 104 in a loose state. For the loosened positioning element 104, on the other hand, the positioning pillars 1041 which are inserted into two sides of the hard disk 11 are also loosened. As a result, the user can pull the loosened positioning element 104, allowing the locking portion 1042 to escape from locking of the corresponding locking portion 1024. Thus, the positioning element 104 is completely separated from the loading seat 101, thereby achieving an object of dismounting the hard disk 11.

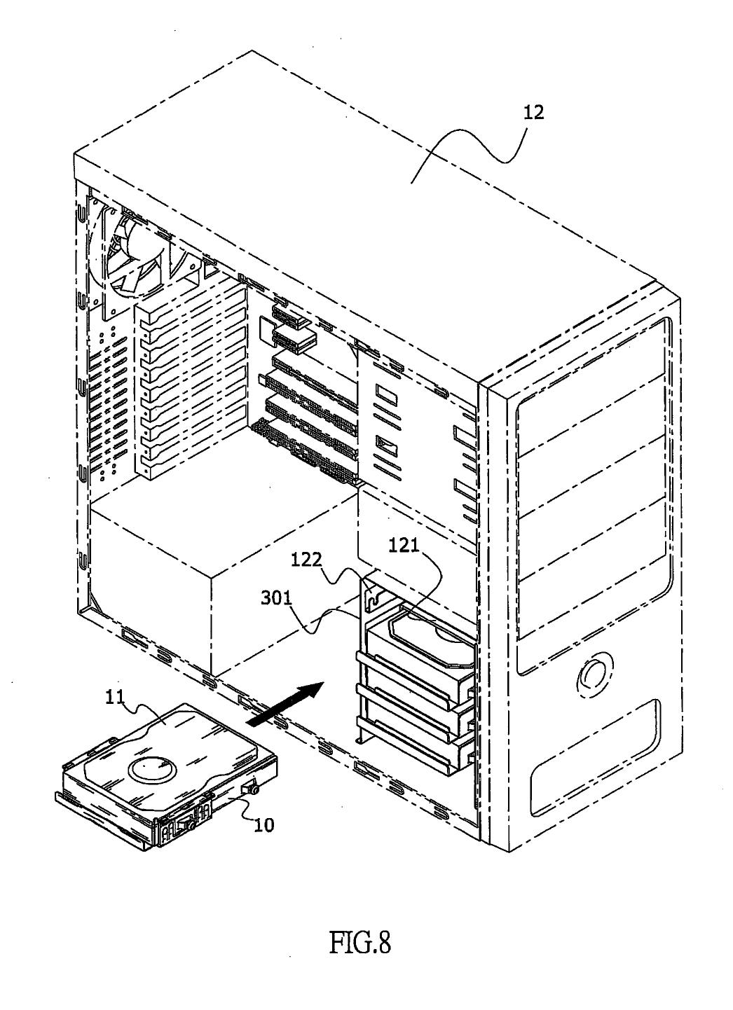

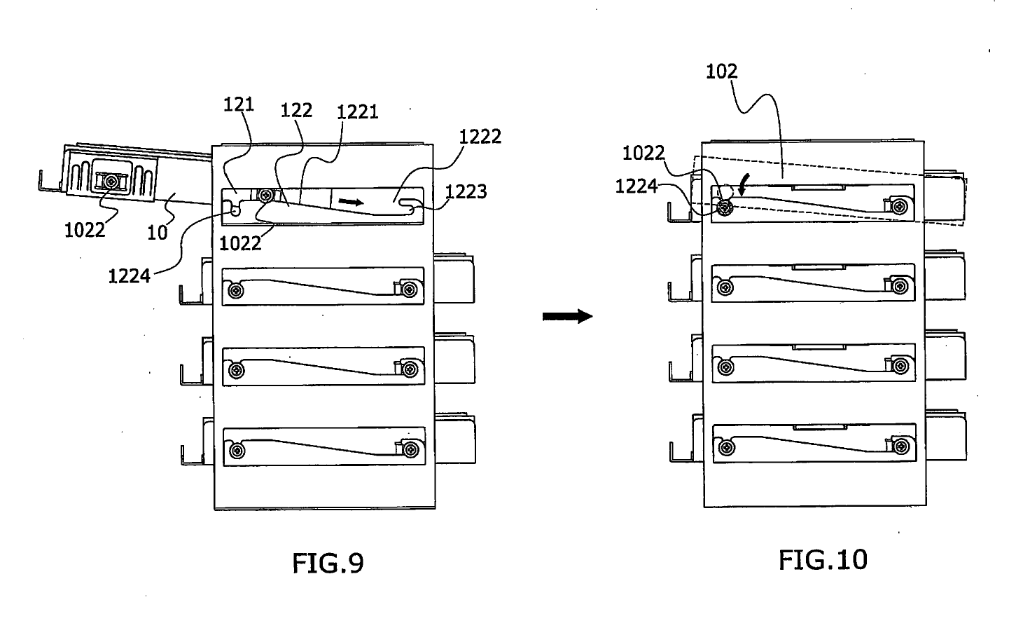

Referring to FIG. 8, it shows a fourth schematic view of an implementation of the present invention. After the hard disk 11 has been completely fixed on the hard disk fixing seat 11, the hard disk fixing seat 11 can be quickly put into an insertion slot 121 of a computer 12. As shown in the drawing, the insertion slot 121 is located at a side in an interior of the computer 12 and two sides of the insertion slot 121 are formed with a corresponding slide rail 122. When the hard disk fixing seat 10 is to be put into the insertion slot 121, an end of the hard disk fixing seat 10 to be put into is made to correspond to the slide rail 121 and is then pushed into after that. Referring to FIG. 9, it shows a fifth schematic view of an implementation of the present invention. When an end of the hard disk fixing seat 10 is put into the insertion slot 121, the locking elements 1022 at two sides will correspond to the slide rails 122 and slide to tail ends 1222 of the slide rails 122 from oblique slide ways 1221 of the slide rails 122, accordingly. In addition, as being a little elastic, the locking elements 1022 will be locked into first locking holes 1223 which are formed at the tail ends 1222 of the slide rails 122. Moreover, referring to FIG. 10, it shows a sixth schematic view of an implementation of the present invention. According to FIG. 9, after the locking elements 1022 have been locked into the first locking holes 1223, the entire hard disk fixing seat 10 is pressed down again, allowing the other locking elements 1022 to be locked into second locking holes 1224 which are formed at front ends of the slide rails 122, thereby accomplishing quick assembling of the entire hard disk fixing seat 10 and the hard disk 11. On the other hand, when dismounting, a front end of the hard disk fixing seat 10 is pushed up first, and then the entire hard disk fixing seat 10 is pulled out accordingly.

Concluding from above, after implementing the present invention, the hard disk that is put on the loading seat can be effectively fixed by the positioning elements, and the fixing elements at two sides of the loading seat can be pushed into the slide rails that are provided at two sides of the insertion slot in the computer case, thereby actually providing a hard disk fixing seat by which a hard disk can be dismounted or assembled without using a hand tool, and which can be quickly plugged into or pulled out of a computer case.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A hard disk fixing seat which is used to hold a hard disk and is quickly assembled in an insertion slot in a computer case, comprising:
a loading seat, two sides of which are bended respectively to form a baffle wall, an upper end of the baffle wall being formed with more than one opposite locking portion, a plane of the baffle wall being protruded to form plural assembly portions and more than one fixing holes, the plural assembly portions being assembled respectively with a locking element and a plane of the loading seat being formed with more than one snap;
more than one positioning element in an L-shape, an end of which is formed with plural locking portions and a plane of which is formed with more than one opposite snap, after the snaps being locked with the corresponding snaps of the baffle wall, the corresponding snaps being locked with the snaps of the loading seat; and
more than one positioning pillar which is formed on a plane of the positioning element opposite to the baffle wall, after the positioning elements being assembled with the loading seat, the positioning pillars being transfixed into the fixing holes of the baffle walls.

2. The hard disk fixing seat according to claim 1, wherein an end of the loading seat is formed with a stop portion.

3. The hard disk fixing seat according to claim 1, wherein a plane of the loading seat is formed with plural through-holes to increase a heat dissipation effect.

4. The hard disk fixing seat according to claim 1, wherein the locking elements are made by an elastic material.

5. The hard disk fixing seat according to claim 1, wherein a plane of the positioning element opposite to the baffle wall is formed with more than one protruded pillar.

6. The hard disk fixing seat according to claim 1, wherein a top end of the positioning pillar is formed with an oblique surface.

7. The hard disk fixing seat according to claim 1, wherein two sides of the insertion slot in the computer case are formed with a slide rail.

8. The hard disk fixing seat according to claim 7, wherein the slide rail is formed with a slide way.

9. The hard disk fixing seat according to claim 7, wherein the slide rail is formed with a first locking hole and a second locking hole.

10. The hard disk fixing seat according to claim 1, wherein the plane of the loading seat is formed with plural vertical positioning pillars to be locked with plural pores formed on a bottom surface of the hard disk.
